(19) United States
(12) Patent Application Publication
(10) Pub. No.: US 2002/0107870 A1
(43) Pub. Date: Aug. 8, 2002

(54) Method for enhanced data dependencies in an XML database

(76) Inventors: Larry Yen, South Pasadena, CA (US); Larry Chang, Walnut, CA (US); Raja Balu, Westlake Village, CA (US)

Correspondence Address: Oppenheimer Wolff & Donnelly LLP, 45 South Seventh Street, Suite 3300, Minneapolis, MN, 55402-1609, US

(21) Appl. No.: 09/992,057

(22) Filed: Nov. 19, 2001

Related U.S. Application Data
(60) Provisional application No. 60/249,904, filed on Nov. 20, 2000.

(51) Int. Cl. G06F 7/00

(52) U.S. Cl. 707/104.1

(57) ABSTRACT

A method and system for building a database to be queried by a parametric search engine begins by receiving data concerning a set of products. Each product is mapped by a set of attributes representing characteristics of the products and values for those characteristics. For some attributes, there can be multiple values. Each of the multiple values is associated with a corresponding multiple value for another attribute, and thus defining a variation of the product. The data is inserted into a database such that the relationship among the interrelated values is retained, permitting a parametric search engine to provide a correct solution set for a query to the database. In one embodiment, the database is an XML database and the products for which the database stores are components for use by engineers during the Discovery phase of Research and Development.

### CROSS-REFERENCE TO RELATED APPLICATIONS

This application claims the benefit of U.S. Provisional Application No. 60/249,904 filed on Nov. 20, 2000, entitled “Method of resolving data dependency problem in database for parametric search engine,” the contents of which are incorporated herein by reference.

### BACKGROUND OF THE INVENTION

The present invention relates to databases and particularly to an XML database for storing characteristics of data that describe characteristics of components or other products.

According to industry sources, the high-tech industry is projected to grow from approximately $610 billion in 1999 to approximately $1.1 trillion in 2004. While the high-tech market is growing rapidly, it is also undergoing rapid change. Although this industry has typically been characterized by complex products, volatile product life cycles and frequent product obsolescence, rapid developments in technology have magnified these characteristics. As a result, high-tech companies face increasing pressure to accelerate the development and delivery of increasingly complex products to remain competitive in their industry. Additionally, manufacturers, suppliers and distributors of technology and component parts are under comparable competitive pressure to quickly and efficiently adjust their inventory to meet the changing product development needs of their high-tech customers.

The high-tech research and development process is highly complex and consists of three logical phases—Discovery, Design and Implementation. The most crucial phase is the Discovery phase because it provides the foundation for a product's development and, if incomplete, may result in a product that is non-competitive or unprofitable, has a short life cycle or violates others' intellectual property. Rather than a linear process, the Discovery phase is an extensive, iterative and organic process, frequently requiring a collaborative, as opposed to an individual, effort. During the Discovery phase, engineers conceptualize an idea, break it down into manageable elements, identify a finite set of possible solutions for each element, test each solution against predefined performance criteria and finally select the optimal solution, while ensuring the interdependencies between each element remains intact. In one method to accomplish this, engineers: (1) create a block diagram of their concept; (2) research vast amounts of specialized information such as algorithms and standards from leading research institutions and industry forums; (3) verify the product concept against protected art to ensure uniqueness; (4) consider the optimal hardware architecture and components to implement the design; (5) investigate available firmware and software from third-party developers to determine “make or buy” decisions; and (6) repeat these steps for each block in their diagram, as many times as necessary to select the optimal component or subsystem for each block, while ensuring the interdependencies between each block remain intact.

For the Discovery process to be effective, engineers need to know what is available from all possible sources as well as what is currently in development. Traditional resources for high-tech Discovery are currently highly fragmented and decentralized, ranging from publications from research institutions, universities, standards forums, patent offices and trade journals to consultations with patent attorneys, field applications engineers and manufacturers' representatives.

Each of these sources suffers from limitations. Some publications do not contain up-to-date information and other sources of information are frequently biased because they contain data only on certain manufacturers' or distributors' products. Still others, such as dissertations or information available only by executing non-disclosure agreements (“NDAs”), are not easily accessible or, in the case of patents, understandable to engineers because they are drafted by lawyers who use their own specialized language. Similarly, consultations are typically incomplete because the knowledge or bias of the consultant limit them.

As a result, Discovery undertaken using traditional resources is costly, inefficient, time consuming, incomplete and prone to error. Moreover, the iterative nature of Discovery exacerbates these shortcomings, making it increasingly difficult for companies using traditional Discovery methods to keep pace with shorter product life cycles and higher growth expectations within the high-tech industry.

Aprisa, Inc. has introduced an interactive Discovery tool available to engineers on the Internet, under the brand name CIRCUITNET. Using this system, once an engineer has generated a system design, a database of objects is queried to find potential components or subsystems for the generic descriptions within the system design.

The CIRCUITNET database is an XML-based database. Like other XML-based databases found in the prior art in the recent years, the database interacts with parametric search engines so that the user can perform queries more complicated than those supported by traditional SQL statements. Parametric search engines can support the traditional search operators (such as “>”, “>=”, “<”, “<=”, “=” and “!=”) as well as mathematical and combinational operators (such as “+”, “−”, “*”, “/”, “IN”, “Not IN”, “Between”, “Not Between”, “Must Have”, and “Must Not Have”).

As one can imagine, the database of component objects used by CIRCUITNET is expansive. Just a year after roll-out, the database includes information on over 2 million components, with 10,000 more components added monthly. Furthermore, records for each component are extensive, including the usual information regarding part number, pricing information and other attributes targeted primarily for procurement, as well as more complicated data, such as, minimum positive supply voltage, data output configuration, ADC sampling rate, and the like. Of course each type of component includes its own series of attributes available to be queried from the database.

In a traditional retail environment, goods are priced individually. However, manufacturers of components, as with other wholesalers, offer their goods based on a pricing matrix. The price is thus interrelated with, for example, the quantity desired and the timeframe for delivery. For example, should a company need 1000 widgets, the price might be $10/widget and delivery can be promised for 10 days. However, should a company need 8,000 widgets, while the price reduces to $8.50/widget, the delivery will take 30 days. These attribute dependencies cause current parametric search engines to incorrectly retrieve solution sets for queries.

What is needed in the art is a method that would assist the search engine to operate correctly.

### SUMMARY OF THE INVENTION

It is one object of the invention to provide a more accurate database of components. Another object of the invention is to provide a system for structuring a database concerning components in a manner that can be correctly queried.

These and other objects of the invention are solved by storing variations of a product in the database. In one embodiment of the invention, a database is created by receiving data concerning a set of products, such as components used by engineers during their design process. Each product is mapped by a set of attributes having values, known as attribute-value pairs. Some products have more than one variation or configuration whereby for some attributes, there are multiple values. Each of the multiple values is associated with a corresponding multiple value of another attribute. The system inserts data into a database such that the relationship among the interrelated values (i.e., the variations) is retained, thus permitting a parametric search engine to provide a correct solution set for a query to the database. In one embodiment, the database is an XML database that stores the records using XML tags. In another embodiment the XML database uses identifiers (such as sequential numbers) to identify the various combination of attributes making up a variation.

### BRIEF DESCRIPTION OF THE DRAWINGS

FIG. 1 is a table representing raw data for characteristics of a product.

FIG. 2 is a diagram of an XML database record for the product from FIG. 1.

FIG. 3 is a table illustrating testing performed by a search engine for a query.

FIG. 4 is a table illustration a second type of testing performed by a search engine for a query.

FIG. 5 is a diagram of an XML database record for a product having two variations.

FIG. 6 is a diagram of a second type of XML database record for a product having two variations.

FIG. 7 is a table illustrating testing performed by a search engine on the XML database records from FIGS. 5 or 6 for a query.

FIG. 8 is a diagram of an XML database record for a component having two configuration variations.

FIG. 9 is a diagram of a second type of XML database record for a component having two configuration variations.

FIG. 10 is a block diagram of a computer having a memory, upon which a database structure in accordance with the present invention is stored.

### DETAILED DESCRIPTION OF PREFERRED EMBODIMENTS OF THE INVENTION

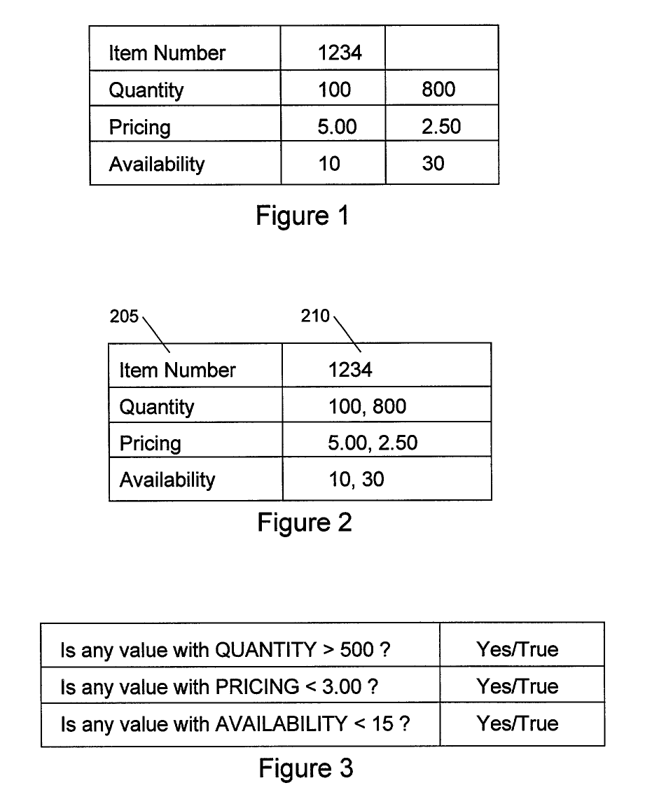

Referring to FIG. 1, raw data for specifications for a component (or some other type of product) shows that such items can be described as a series of attributes, for example, quantity, pricing, and availability. As the matrix shows in FIG. 1, when 100 units of the item are ordered, the pricing is $5.00/unit and items will be shipped in 10 days. When the quantity is 800, the price lowers to $2.50/unit, but it will take 30 days for shipment. When the raw data from FIG. 1 is stored in an XML database record, it is stored as a series of attribute-value pairs where each attribute 205 may have one or more values 210.

With such an item stored in a database, a user may perform a search such as:

find ITEM

where QUANTITY>500

and PRICING <3.00

and AVAILABILITY <15

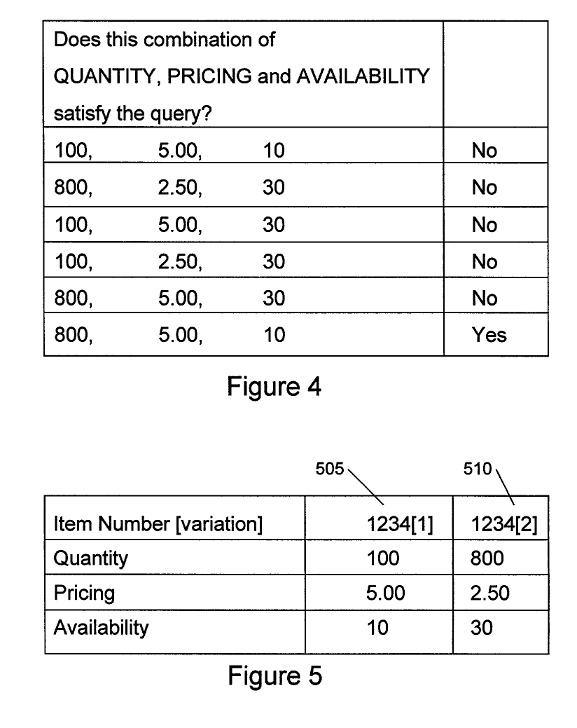

A traditional parametric search engine returns Item Number 1234 as satisfying the query, even though it does not. The search engine reaches this false conclusion by inspecting each value within a multi-valued attribute one at a time, or by testing all combinations of attributes within the record. In the former method, the search engine can be thought of as performing the testing shown in FIG. 3. Since all three sub-tests shown in FIG. 3 are TRUE, item 1234 is falsely returned as satisfying the query. For the latter combination-type method, the search engine performs testing shown in FIG. 4. Because at least one combination of values evaluates as “YES,” the search engine incorrectly returns the record for item #1234 as a result for the query.

To solve this problem, the present invention restructures the XML database by subadding an additional layer of information to the database. The additional layer is referred to as a VARIATION. By implementing variations in the XML database, the record for item number #1234 is stored with two valid variations (where the variation value is indicated within brackets for one embodiment), as shown in FIG. 5. In other embodiments, rather than use sequential number to identify the various combination of attributes making up a variation, other identifiers are used.

Thus, FIG. 5 shows that variation 1 of the item 1234 (element 505) describes the interrelationship of the quantity, pricing and availability values when quantity is 100. variation 2 (element 510) of the item shows the interrelationship when quantity is 800. By separating the same item with different variations, the database associates the multiple values of the QUANTITY, PRICING, and AVAILABILITY attributes according to their interrelationships.

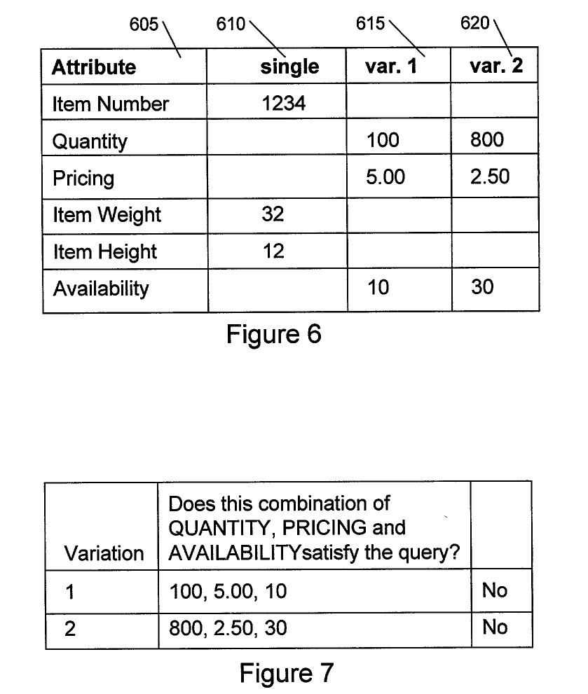

In another embodiment of the present invention, attributes that do not have multiple values are only stored once within the structure of the record. Variations are made up of the single-valued attributes in connection with a combination of interrelated multi-valued attributes. FIG. 6 shows one representation of this type of XML record, where attributes 605, single values for attributes 610, and variations 615 and 620 having multiple values for attributes are structured.

Another embodiment of the present invention organizes the data as a series of XML tags having attribute-value pairs, such as:

<item>

<attribute name=‘item-number’ value=‘1234’/>

<attribute name=‘quantity’>

<variation number=‘1’ value=‘100’/>

<variation number=‘2’ value=‘800’/>

</attribute>

<attribute name=‘pricing’>

<variation number=‘1’ value=‘5.00’/>

<variation number=‘2’ value=‘2.50’/>

</attribute>

<attribute name=‘item-weight’ value=‘32’/>

<attribute name=‘item-height’ value=‘12’/>

<attribute name=‘availability’>

<variation number=‘1’ value=‘10’/>

<variation number=‘2’ value=‘30’/>

</attribute>

</item>

Regardless of the implementation, the record for an item can be logically constructed as a series of attributes (such as pricing, or item weight), where each attribute has a value, and where some values can be multi-valued. When values are multi-valued, the first value for each multi-valued attribute are interrelated to form a variation of the item, the second value for each multi-valued attribute are interrelated to form a second variation of the item, and so forth.

The interrelationships of the multi-valued attributes within the record allow a parametric search engine to correctly query the database. Instead of performing the six combination-type tests, as shown in FIG. 4, the search engine recognizes that the item has two variations and therefore will only perform the two tests shown in FIG. 7. Because neither variation test is true, the search engine will not include the item as part of the returned answer set. Thus, the invention corrects the search engine from returning false results. The enhanced structure of the present invention that stores the interdependency of the attributes within a record allows the search engine to ignore combinations that are not available (thus saving 4 combination tests in the example from FIG. 7). This may result in a quicker response time by the search engine.

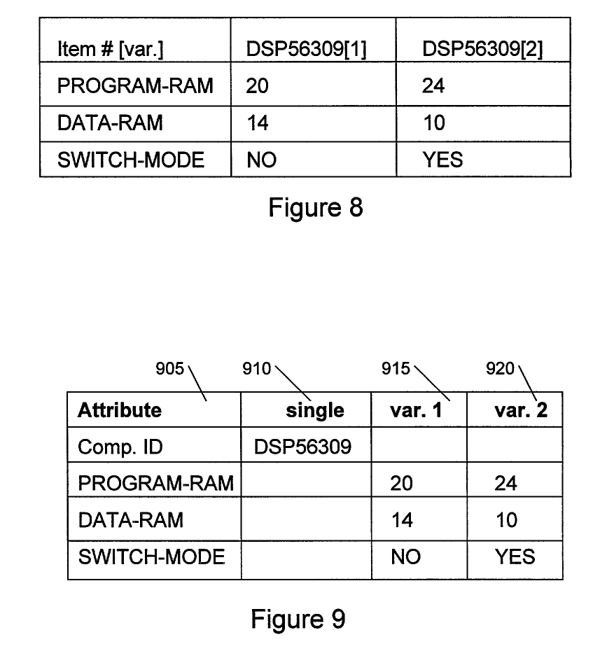

FIGS. 8 and 9 are a second example of the present invention as directed to an XML database for storing component data for use with Applicant's CIRCUITNET discovery tool. In FIG. 8, the XML record for MOTOROLA's fixed-point DSP processor is stored to show that it is available in two configurations (i.e., variations). The first configuration has 20 Kwords of internal program RAM, 14 Kwords of internal data RAM, and does not have a memory switch mode. The second configuration has 24 Kwords of internal program RAM, 10 Kwords of internal data RAM, and does have a memory switch mode. FIG. 9 shows another embodiment of this record in which values that are the same for all variations are only stored once in the record, such as the Component ID. As with the first example, XML tags can also be used, such as:

<item>

<attribute name=‘component-id’ value=‘DSP56309’/>

<attribute name=‘program-ram’>

<variation number=‘1’ value=‘20’/>

<variation number=‘2’ value=‘24’/>

</attribute>

<attribute name=‘data-ram’>

<variation number=‘1’ value=‘14’/>

<variation number=‘2’ value=‘10’/>

</attribute>

<attribute name=‘switch’>

<variation number=‘1’ value=‘no’/>

<variation number=‘2’ value=‘yes’/>

</attribute>

</item>

With such data (from FIGS. 8, 9, or the XML tags above) stored in an XML database, a parametric search engine may perform the query:

find component where size of internal program RAM>22 and size of internal data RAM>12

and correctly return neither variation of the DSP56309 component as meeting the search requirements.

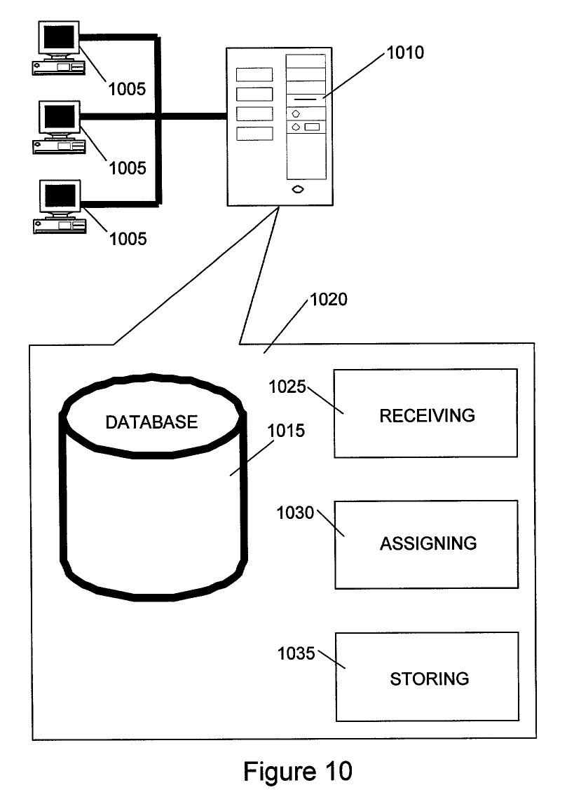

FIG. 10 is a block diagram of a computer having a memory, upon which a database structure in accordance with the present invention is operated. In FIG. 10 a series of client computers 1005 are networked to a server computer 1010. In the server computer's memory 1020, an XML database 1015 is stored. This database 1015 organizes a series of objects, each object used to describe a series of attributes for a component or other product. In one embodiment, the computer memory 1020 also includes one or more computer programs or code segments that provide the functionality to properly structure the database 1015 in accordance with the present invention. One code segment receives 1025 data for a product. Another code segment assigns 1030 an object from the database 1015 to represent the product. Another code segment stores 1035 in the object the values for the attributes describing the product. In one embodiment, the client computers 1005 and server computer 1010 are merged into a single computer, such as a PC or laptop.

### Use of the Enhanced Database by Engineers during Discovery

During the Discovery step of research and development, an engineer generates a block diagram of a system to be designed. The block diagram is made up of a series of interconnected blocks. Each of these blocks represents a component or subsystem (since systems are often hierarchical, containing various levels of subsystems and components). Throughout this application, the use of “component” refers not only to true components, but also includes subsystems.

One of the primary goals of the Discovery phase is for the engineer to create a conceptual design of a product which can then be used in the Design phase to create manufacturable specifications. In Discovery, an engineer refines a design of a system by researching each of the design's components to come up with a near-optimal solution of the exact components that should be used. The near-optimal solution is based on the compatibility of the various components as well as various predefined criteria. Choosing which element to use for each component of a design is very difficult because there are numerous factors to take into account. Price and availability are two such factors. Compatibility with the rest of the components to be placed in the design is another factor. Due to the number of manufacturers for any given category of product, and because all of these manufacturers are continually introducing new and improved products, an engineer is challenged with an ever increasing amount of information to consider during Discovery.

Newer Discovery tools, such as CIRCUITNET, provide databases that store product and design related objects, including systems, subsystems, micro-systems, components, products, vendors, and other sub-units. In one embodiment, such a database can be an SQL database on an NT server. Databases such as the one provided in CIRCUITNET can be queried to find components that will work together to form the near-optimal solution.

The database allows the engineer to choose one of the blocks from his block diagram. To retrieve all components which can be used to implement this block, the engineer constructs a search query which includes the necessary limitations. For example, suppose the engineer is designing a simple computer system made up of a CPU, a memory, and a clock. For various reasons, the engineer may determine that the CPU must operate at least at a speed of 800 megahertz. Because of business restrictions, the engineer may be prevented from utilizing any components manufactured by a certain corporation (“XYZ Corp.” for example). The CPU may need to be PC compatible and have an operating voltage of between 2.2 and 3.3 volts. From these limitations, the engineer can build a parametric search query, such as:

Clock-Speed>800

AND

Manufacturer!=“XYZ”

AND

Compatibility=“PC”

AND

Voltage BETWEEN (2.2, 3.3).

Furthermore, the engineer may be faced with a limitation which depends on one of the component's own attributes, or upon an attribute of an earlier portion of the design. For example, perhaps there is a requirement that the CPU component is of military grade and the engineer is allowed to incorporate CPUs that cost up to $25. With this additional requirement, the engineer can expand the search query rules to be:

Component-Grade MH (Military-Grade)

AND

Clock-Speed>800

AND

Manufacturer !=“XYZ”

AND

Compatibility =“PC”

AND

Voltage BETWEEN (2.2, 3.3)

AND

Cost<25.00

(Note: the MH() operator is used to indicate that an attribute must have a specified value.)

The parametric search engine may parse the parameters from the entered search query to generate the actual query submitted to the database. In current parametric search engines, if a component selected from the database has multiple values for an attribute, then all possible combinations of the values of the attributes is first computed, and all those combinations that satisfies the parametric query is included in the results listed to the user. However, by using the present invention, the XML database correctly stores the variations for each component. Thus, the interrelationship of the values for various attributes are maintained, allowing the parametric search engine to return proper results to the engineer users.

From the foregoing detailed description, it will be evident that there are a number of changes, adaptations and modifications of the present invention which come within the province of those skilled in the art. However, it is intended that all such variations not departing from the spirit of the invention be considered as within the scope thereof. Discussed herein has been a database used to store information regarding products, items, and components. One skilled in the art will recognize that the solution provided by the invention can be used for other types of objects having a series of attributes that may have variations of interrelated values. Also, while the discussion herein has shown products having two variations, the present invention supports products having any number of variations.

What is claimed is:

1. A computer storage medium storing a database controlled by a computer, wherein the database contains information about a plurality of products;
wherein each product has a first and second attribute in the database representing two characteristics for the plurality of products;
wherein the first attribute has a first and second values in the database representing two values for the characteristic of the product represented by the first attribute;
wherein the second attribute has a third and fourth value in the database representing two values for the characteristic of the product represented by the second attribute; and
wherein the first value is related to the third value and the second value is related to the fourth value.

2. The computer storage medium storing a database controlled by a computer from claim 1, wherein the plurality of products are components used by engineers.

3. The computer storage medium storing a database controlled by a computer from claim 1, wherein the database is an XML database.

4. The computer storage medium storing a database controlled by a computer from claim 1, further wherein the database saves a first variation for one of the products representing the dependency of the first value associated to the first attribute and the third value associated to the second attribute; and
wherein the database saves a second variation for the product representing the dependency of the second value associated to the first attribute and the fourth value associated to the second attribute.

5. A system for populating a database in a computer system, wherein the database stores a plurality of objects representing a plurality of products, wherein each object has a first and second attribute representing two characteristics for the products, wherein the first attribute has a first and second values representing two values for the characteristic of the product represented by the first attribute, and wherein the second attribute has a third and fourth value representing two values for the characteristic of the product represented by the second attribute, the system comprising:
a receiver unit that receives data for a product;
an assignment unit that assigns an object from the plurality of objects in the database to represent the product; and a storing unit that stores in the object the first, second, third, and fourth values for the product;
wherein the first value is related to the third value and the second value is related to the fourth value.

6. The system for populating a database from claim 5, wherein the plurality of products are components used by engineers.

7. The system for populating a database from claim 5, wherein the database is an XML database.

8. The system for populating a database from claim 5, wherein the storing unit saves a first variation for one of the products representing the dependency of the first value associated to the first attribute and the third value associated to the second attribute; and
wherein the storing unit saves a second variation for the product representing the dependency of the second value associated to the first attribute and the fourth value associated to the second attribute.

9. A computer storage medium storing a database controlled by a computer, wherein the database stores information about a plurality of products;
wherein a product from the plurality of products has two variations;
wherein each product has a first and second attribute in the database representing two characteristics for the product stored in the database;
wherein the first and second attributes each have a first value representing a first variation for the product;
wherein the first and second attributes each have a second value representing a second variation for the product; and
wherein a first identifier is associated with the first values and a second identifier is associated with the second values to label the first and second variation respectively.

10. The computer storage medium storing a database controlled by a computer from claim 9, wherein the plurality of products are components used by engineers.

11. The computer storage medium storing a database controlled by a computer from claim 9, wherein the database is an XML database.

12. A computer program for populating a database, the computer program embodied on a computer readable medium for execution by a computer, wherein the database stores a plurality of objects representing a plurality of products, wherein each object has a first and second attribute representing two characteristics for the products, wherein the first attribute has a first and second values representing two values for the characteristic of the product represented by the first attribute, and wherein the second attribute has a third and fourth value representing two values for the characteristic of the product represented by the second attribute, the computer program comprising:
a code segment that receives data for a product;
a code segment that assigns an object from the plurality of objects in the database to represent the product; and
a code unit that stores in the object the first, second, third, and fourth values for the product;
wherein the first value is related to the third value and the second value is related to the fourth value.

13. The computer program for populating a database from claim 12, wherein the plurality of products are components used by engineers.

14. The computer program for populating a database from claim 12, wherein the database is an XML database.

15. The computer program for populating a database from claim 12, wherein the code segment that stores saves a first variation for one of the products representing the dependency of the first value associated to the first attribute and the third value associated to the second attribute; and
wherein the code segment that stores saves a second variation for the product representing the dependency of the second value associated to the first attribute and the fourth value associated to the second attribute.
